(19) United States
(12) Patent Application Publication
(10) Pub. No.: US 2002/0091881 A1
(43) Pub. Date: Jul. 11, 2002

(54) Managing a failure to access a database in a computer system

(75) Inventors: Frank Leymann, Aidlingen (DE); Dieter Roller, Schoenaich (DE)

Correspondence Address: A. Bruce Clay, IBM Corporation, Dept. T81/Bldg. 503, P.O. Box 12195, Research Triangle Park, NC, 27709, US

(73) Assignee: International Business Machines Corporation, Armonk, NY

(21) Appl. No.: 10/042,799

(22) Filed: Jan. 9, 2002

(30) Foreign Application Priority Data
Jan. 10, 2001 (EP) 01100570.9

(51) Int. Cl. G06F 3/00

(52) U.S. Cl. 710/4

(57) ABSTRACT

A method of operating a computer system is described. The computer system comprises at least one application client (15), at least two application servers (20, 21) which are suitable to process requests of the application client (15), and a database (26) which may be accessed by the two application servers (20, 21). The method comprises the steps of recognising that the first one of the two application servers (21) fails to access the database (26), sending a request of the application client (15) for the first application server (21) from the first application server (21) to the second application server (20), processing the request by the second application server (20), and sending a response to the request from the second application server (20) to the first application server (21).

Managing a Failure to Access a Database in a Computer System The invention relates to a method of operating a computer system, wherein said computer system comprises at least one application client, at least two application servers which are suitable to process requests of the application clients, and a database which may be accessed by the two application servers. The invention also relates to a corresponding computer program or computer program product as well as to a corresponding computer system.

If e.g. the first one of the two application servers has no connection anymore to the database, or if e.g. the database management system of the first application server has an abnormal termination, i.e. if the first application server fails to access the database, then, in prior art computer systems, the application client is informed by the failing application server about the loss of connection to the database. Then, the application client may select e.g. the second application server in order to have this application server process the request of the application client.

A disadvantage of the prior art is the fact that the application client must select an available application server based on information that the application client keeps or obtains about the state of each of the application servers.

Another disadvantage of the prior art is the fact that, if the application server fails to access to the database, a request already received by the application server before the database connection got lost, can not be processed and must be returned to the application client. It is then the responsibility of the application client to handle the situation.

It is a further disadvantage of the prior art that in case the application server reconnects successfully to the database, the application client must engage with the application servers in a rather complex fall back processing to work again with the original application server.

It is therefore an object of the invention to provide a method of operating a computer system such that in all cases of a loss of connection between any of the application servers and the database, all requests to be processed by the failing application server are performed without an undue delay and without requiring a lot of additional procedures.

This object is solved by the invention with the steps of recognising that the first one of the two application servers fails to access the database, sending a request of the application client for the first application server from the first application server to the second application server, processing the request by the second application server, and sending a response to the request from the second application server to the first applicaton server.

The inventive method does not, in case of a failure of one of the application servers, fall back to the application clients. Instead, the application server that has no connection anymore to the database sends the request to be processed directly to another application server. As an advantage, the invention does not require a lot of additional fall back procedures. Instead, the invention only requires some procedures which enable the first application server to send one or more requests to the second application server. Apparently, such sending procedures are less complex and less extensive compared to the fall back procedures needed by the prior art.

In an advantageous first embodiment of the invention, a further step comprises the sending of the response from the second application server to an input queue of the first application server. As a result, the response is available at the first application server. The first application server is able to recognise that the response corresponds to a request that it received before by having the second application server returning sufficient information to recognise this as a response to a previously forwarded request from the application client. Then, the first application server puts the received response from the input queue to its output queue.

In an advantageous second embodiment of the invention, a further step comprises the sending of the response from the second application server to the output queue of the first application server. This second embodiment therefore constitutes a simplification of the first embodiment in that the response to the request is directly sent from the second application server to the output queue of the first application server.

Furthermore, it is advantageous to provide the further step of sending the response from the output queue to the application client.

Further advantages and embodiments of the invention are shown in the accompanying figures and will be described in detail now.

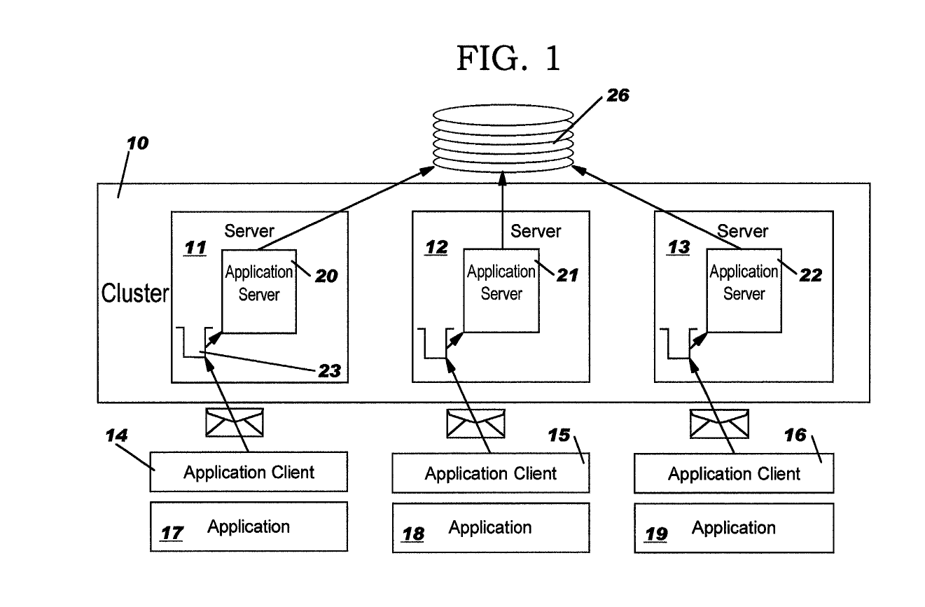

FIG. 1 shows a computer system according to the invention,

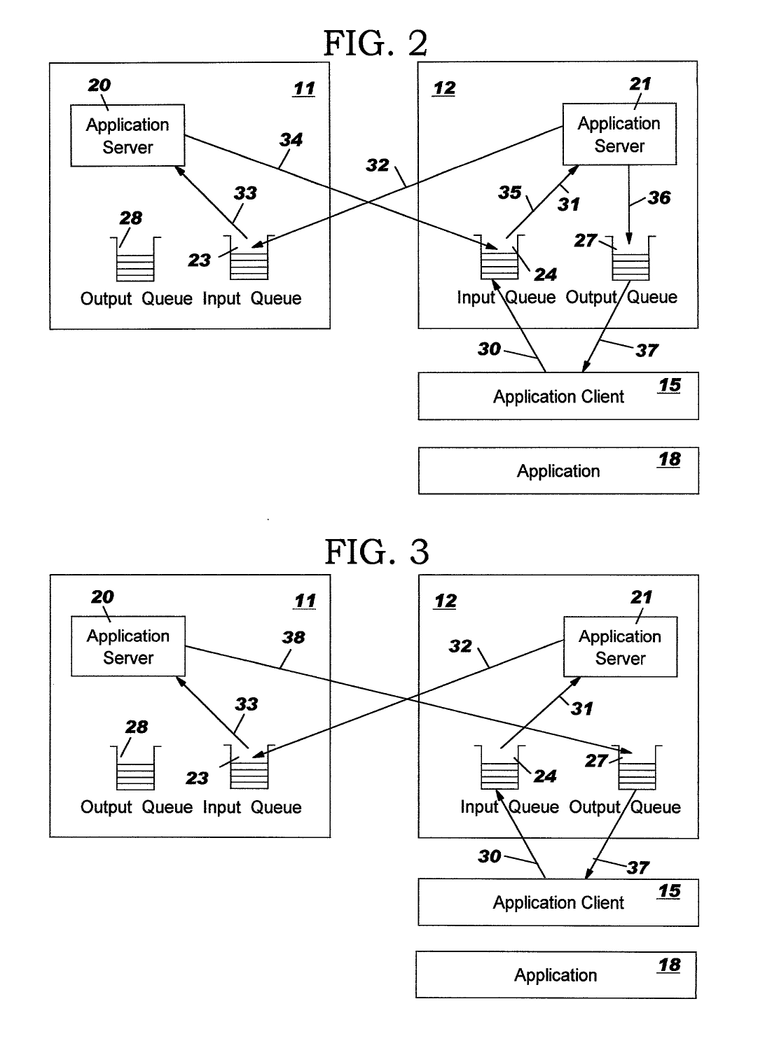

FIG. 2 shows a schematic diagram of a first embodiment of a method of operating the computer system of FIG. 1 according to the invention, and

FIG. 3 shows a schematic diagram of a second embodiment of a method of operating the computer system of FIG. 1 according to the invention.

FIG. 1 shows a computer system with a cluster 10 of servers 11, 12, 13 and a number of application clients 14, 15, 16. Each of the servers 11, 12, 13 hosts one or more application servers 20, 21, 22, that implement specific services, which are provided to the application clients 14, 15, 16. These services are requested from the application clients 14, 15, 16 by applications 17, 18, 19. Each of the applications 17, 18, 19 and the corresponding application clients 14, 15, 16 may run on the same machine.

Each of the servers 11, 12, 13 of the cluster 10 is usually a different machine which fails independently from each other. The communication between the application servers 20, 21, 22 and the application clients 14, 15, 16 is typically based on an asynchronous message exchange.

Each of the servers 11, 12, 13 includes an input queue 23, 24, 25, into which the corresponding application clients 14, 15, 16 put their requests and from which the application servers 20, 21, 22 read the requests.

FIG. 1 shows a database 26 which is accessed by the application servers 20, 21, 22. The database 26 is shared between all application servers 20, 21 and 22. By using the database 26, the application servers 20, 21, 22 can be built stateless, that means all states that are necessary to be kept between subsequent requests are stored in the database 26 and all requests from the applications clients 14, 15, 16 are carried out as a transaction providing for full recovery of all requests. By using the shared database 26, each of the application servers 20, 21, 22 can process requests from the application clients 14, 15, 16.

In case of a situation in which one of the application servers 20, 21, 22 has no connection anymore to the database 26, a method is performed which will be described now. The mentioned situation may occur e.g. if a physical line between one of the application servers 20, 21, 22 and the database 26 brakes down or if the database management system used by one of the application servers 20, 21, 22 terminates abnormally or if one of these database management systems has to be fixed for whatever other reason.

In general, the application servers 20, 21, 22 can detect the loss of the connection to the database 26. The can also detect that the connection to the database 26 can be established again by, for example, periodically checking whether a connection can be established. As an option, the application servers 20, 21, 22 could also provide the capability to accept commands that signal the loss of the connection and the availability of the connection.

FIG. 2 shows a first embodiment of a method how to solve a loss of connection between one of the application servers 20, 21, 22 and the database 26. FIG. 2 shows, as an example, the application 18 with the corresponding application client 15. As well, again as an example, the application servers 20 and 21 are shown with the input queues 23 and 24. Furthermore, each of the application servers 20 and 21 comprises an output queue 27, 28.

In FIG. 2, the application client 15 sends its request as usual to the input queue 24 of the corresponding server 12. This step is expressed in FIG. 2 with reference numeral 30. The application server 21 checks the input queue 24 and finds the request of the application client 15. In FIG. 2, this is shown by reference numeral 31. As the application server 21 has no connection to the database 26, it routes the request of the application client 15 to the input queue 23 of the application server 20 of the server 11. This step is expressed in FIG. 2 with reference numeral 32.

The substitute application server 20 reads the received request from its input queue 23, processes it and creates a response to the request. This is shown in FIG. 2 by reference numeral 33. After having processed the request of the application client 15, the substitute application server 20 sends the created response back to the input queue 24 of the original application server 21. This is expressed in FIG. 2 with reference numeral 34. The original application server 21 reads this response, which is shown in FIG. 2 with reference numeral 35. The original application server 21 then recognizes this response as a response to a previous request and puts it into its output queue 27. This step is expressed in FIG. 2 with reference numeral 36. From there, the application client 15, which, at the beginning of the method, created the request, reads out the response. This step is shown in FIG. 2 by reference numeral 37.

FIG. 3 shows a second embodiment of a method how to solve a loss of connection between one of the application servers 20, 21, 22 and the database 26. FIG. 3 is a simplification of the method described in connection with FIG. 2. Insofar, the features and functions of FIG. 3 correspond to the features and functions of FIG. 2. The same is valid for the reference numerals of FIG. 3 which correspond to the reference numerals of FIG. 2.

The difference between the methods of FIG. 3 and FIG. 2 is as follows: In FIG. 2, the substitute application server 20 puts the created response back into the input queue 24 of the original application server 21 which then puts the response into its output queue 27. In contrast thereto, the substitute application server 20 of FIG. 3 sends the created response directly to the output queue 27 of the original application server 21. This direct step is expressed in FIG. 3 with reference numeral 38. From there, the application client 15 reads out the response as it is expressed with reference numeral 37 and as it is also done in FIG. 2.

1. Method of operating a computer system, wherein said computer system comprises at least one application client (15), at least two application servers (20, 21) which are suitable to process requests of the application clients (15), and a database (26) which may be accessed by the two application servers (20, 21), and wherein said method comprises the steps of recognising that the first one of the two application servers (20, 21) fails to access the database (26), sending a request of the application client (15) for the first application server (21) from the first application server (21) to the second application server (20), processing the request by the second application server (20), and sending a response to the request from the second application server (20) to the first application server (21).

2. Method of claim 1 comprising the further step of sending the response from the second application server (20) to an input queue (24) of the first application server (21).

3. Method of claim 2 comprising the further step of putting, by the first application server (21), the response from the input queue (24) to an output queue (27) of the first application server (21).

4. Method of claim 1 comprising the further step of sending the response from the second application server (20) to an output queue (27) of the first application server (21).

5. Method of one of claims 3 or 4 comprising the further step of sending the response from the output queue (27) to the application client (15).

6. Computer program or computer program product which is suitable to perform the method of one of claims 1 to 5 when it is loaded into a computer system.

7. Computer system comprising at least one application client (15), at least two application servers (20, 21) which are suitable to process requests of the application clients (15), a database (26) which may be accessed by the application servers (20, 21), means for recognising that the first one of the two application servers (21) fails to access the database (26), means for sending a request of the application client (15) for the first application servers (21) from the first application server (21) to the second application server (20), means for processing the request by the second application server (20), and means for sending a response to the request from the second application server (20) to the first application server (21).

8. Computer system of claim 7 further comprising an input queue (24) corresponding to the first application server (21).

9. Computer system of claim 7 or 8 further comprising an output queue (27) corresponding to the first application server (21).

10. Computer system of one of claims 7 to 9 wherein a number of application clients (14, 15, 16) are provided.
